(19) United States
(12) Patent Application Publication
(10) Pub. No.: US 2010/0030689 A1
(43) Pub. Date: Feb. 4, 2010

(54) Transaction authentication system and method

(76) Inventors: Asael Ramos, Charlotte, NC (US); Key Ramos, Charlotte, NC (US)

Correspondence Address: Steven Thrasher, 391 Sandhill Dr., Richardson, TX, 75080, US

(21) Appl. No.: 12/460,294

(22) Filed: Jul. 16, 2009

Related U.S. Application Data
(63) Continuation-in-part of application No. 10/847,008, filed on May 17, 2004, now abandoned.

(51) Int. Cl. G06Q 20/00; G06Q 40/00; G06F 15/16; H04M 3/42; H04M 11/00

(52) U.S. Cl. 705/44; 709/206; 455/414.1; 379/91.01

(57) ABSTRACT

The invention teaches the verifying a financial transaction by requiring an account holder to verify the transaction when the transaction is tagged for verification. It is emphasized that this abstract is provided to comply with the rules requiring an abstract that will allow a searcher or other reader to quickly ascertain the subject matter of the technical disclosure. It is submitted with the understanding that it will not be used to interpret or limit the scope or meaning of the claims. 37 CFR 1.72(b).

### CROSS-REFERENCE TO RELATED APPLICATIONS

This application is a continuation-in-part of, is related to, and claims priority from U.S. patent application Ser. No. 10/847,008 entitled Financial Transaction Verification to Ramos, et al, filed May 5, 2004, and is also related to and claims priority from US Provisional patent application entitled Transaction Authentication System and Method to Ramos, et al, filed Jul. 16, 2008.

### TECHNICAL FIELD OF THE INVENTION

The invention relates generally to financial transactions, and more particularly to insuring the authenticity of the user of the financial transaction.

### PROBLEM STATEMENT

### Interpretation Considerations

This section describes the technical field in more detail, and discusses problems encountered in the technical field. This section does not describe prior art as defined for purposes of anticipation or obviousness under 35 U.S.C. section 102 or 35 U.S.C. section 103. Thus, nothing stated in the Problem Statement is to be construed as prior art.

### DISCUSSION

Identity theft and unauthorized use of financial accounts via credit cards and debit cards cost consumers and businesses billions of dollars each year. Amazingly, unauthorized use of financial accounts occurs despite measures designed to prevent it (such as signature comparisons, and personal identification numbers, for example). Accordingly, there exist the need for systems and methods for preventing the unauthorized use of a financial account.

### BRIEF DESCRIPTION OF THE DRAWINGS

Various aspects of the invention, as well as an embodiment, are better understood by reference to the following detailed description. To better understand the invention, the detailed description should be read in conjunction with the drawings in which:

FIG. 1 shows a financial processing system.

FIG. 2 is a flow diagram of a method of establishing parameters and attribute triggers.

FIG. 3 is a flow diagram of a method of securely processing a financial transaction.

FIG. 4 is a flow diagram of a method of using a financial processing verification system to authenticate a transaction.

FIG. 5 illustrates access from a functionality perspective.

FIG. 6 is an overview of an exemplary architecture of the over-arching system.

FIG. 7 is an overview of an exemplary architecture of the inventive core system.

FIG. 8 is a block-flow diagram illustrating the acts for a user registration.

FIG. 9 is a block-flow diagram illustrating the acts for contact center assistance.

FIG. 10 is a block-flow diagram illustrating the acts for a transaction authorization.

FIG. 11 illustrates a domain object model overview.

FIG. 12 shows an exemplary deployment scenario.

### EXEMPLARY EMBODIMENT OF A BEST MODE

### Interpretation Considerations

When reading this section (An Exemplary Embodiment of a Best Mode, which describes an exemplary embodiment of the best mode of the invention, hereinafter “exemplary embodiment”), one should keep in mind several points. First, the following exemplary embodiment is what the inventor believes to be the best mode for practicing the invention at the time this patent was filed. Thus, since one of ordinary skill in the art may recognize from the following exemplary embodiment that substantially equivalent structures or substantially equivalent acts may be used to achieve the same results in exactly the same way, or to achieve the same results in a not dissimilar way, the following exemplary embodiment should not be interpreted as limiting the invention to one embodiment.

Likewise, individual aspects (sometimes called species) of the invention are provided as examples, and, accordingly, one of ordinary skill in the art may recognize from a following exemplary structure (or a following exemplary act) that a substantially equivalent structure or substantially equivalent act may be used to either achieve the same results in substantially the same way, or to achieve the same results in a not dissimilar way.

Accordingly, the discussion of a species (or a specific item) invokes the genus (the class of items) to which that species belongs as well as related species in that genus. Likewise, the recitation of a genus invokes the species known in the art. Furthermore, it is recognized that as technology develops, a number of additional alternatives to achieve an aspect of the invention may arise. Such advances are hereby incorporated within their respective genus, and should be recognized as being functionally equivalent or structurally equivalent to the aspect shown or described.

Second, the only essential aspects of the invention are identified by the claims. Thus, aspects of the invention, including elements, acts, functions, and relationships (shown or described) should not be interpreted as being essential unless they are explicitly described and identified as being essential. Third, a function or an act should be interpreted as incorporating all modes of doing that function or act, unless otherwise explicitly stated (for example, one recognizes that “tacking” may be done by nailing, stapling, gluing, hot gunning, riveting, etc., and so a use of the word tacking invokes stapling, gluing, etc., and all other modes of that word and similar words, such as “attaching”).

Fourth, unless explicitly stated otherwise, conjunctive words (such as “or”, “and”, “including”, or “comprising” for example) should be interpreted in the inclusive, not the exclusive, sense. Fifth, the words “means” and “step” are provided to facilitate the reader's understanding of the invention and do not mean “means” or “step” as defined in §112, paragraph 6 of 35 U.S.C., unless used as “means for—functioning—” or “step for—functioning—” in the Claims section. Sixth, the invention is also described in view of the Festo decisions, and, in that regard, the claims and the invention incorporate equivalents known, foreseeable, and unforeseeable. Seventh, the language and each word used in the invention should be given the ordinary interpretation of the language and the word, unless indicated otherwise.

Some methods of the invention may be practiced by placing the invention on a computer-readable medium. Computer-readable mediums include passive data storage, such as a random access memory (RAM) as well as semi-permanent data storage such as a compact disk read only memory (CD-ROM). In addition, the invention may be embodied in the RAM of a computer and effectively transform a standard computer into a new specific computing machine.

Data elements are organizations of data. One data element could be a simple electric signal placed on a data cable. One common and more sophisticated data element is called a packet. Other data elements could include packets with additional headers/footers/flags. Data signals comprise data, and are carried across transmission mediums and store and transport various data structures, and, thus, may be used to transport the invention. It should be noted in the following discussion that acts with like names are performed in like manners, unless otherwise stated.

Of course, the foregoing discussions and definitions are provided for clarification purposes and are not limiting. Unless otherwise indicated, acronyms used have the ordinary meaning of those acronyms in the context presented, and are readily understood by those of ordinary skill in the art. Words and phrases are to be given their ordinary plain meaning unless indicated otherwise.

### DESCRIPTION OF THE DRAWINGS

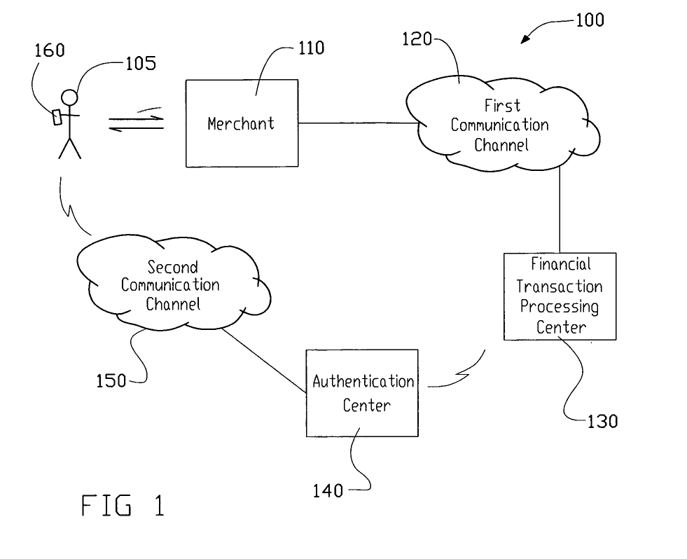

The invention's embodiments may be better understood by reference to the drawings, in which FIG. 1 shows a financial processing system. The invention, in one embodiment, can be characterized as a financial processing verification system 100 (the system 100). One purpose of a financial processing verification system is to allow a merchant 110 to more reliably process transactions, and to give a user 105 of the system the peace of mind that comes with knowing that someone else cannot easily use his financial accounts without his knowledge and affirmation (i.e. to reduce the likelihood of identity theft). In general, the system 100 comprises a first communication channel 120, which may be a wire-line Plain Old Telephone System (POTS) channel, a wireless channel including mobile phone, pager, and satellite channels, the Internet, or any other communication channel that is adapted to process financial transactions. The first communication channel 120 is in communication with a financial transaction processing center 130 (the processing center 130). In one embodiment, the processing center 130 is used to verify a financial transaction in a manner presently known in the art—namely, checking a credit card number and expiration date against a database that stores available funds. In an alternative embodiment, the processing center 130 comprises computers and software needed to communicate with the first communication channel 120, as well as account balance and other information not subject to a user authentication for subscribers to a verification service, discussed below. Of course, although a single processing center 130 is shown, it is appreciated that the processing center 130 may be dispersed, for example, among many buildings, states, or even nations.

An authentication center 140 is in communication with the financial transaction processing center. The authentication center 140 may be co-located with the financial transaction processing center 130, and, indeed, be a component of a larger processing system. The authentication center 140 includes processing and software adapted to control and store parameters, as well as triggers, which are discussed below. In addition, the processing center 140 may be adapted to allow user log-ins and user control over parameters, or such log-in and control functions may be maintained outside the presently discussed system. A second communication channel 150 is in communication with the authentication center, and allows the authentication center to communicate with a user 105 via a data entry device 160. The second communication channel 150 may be a wire-line Plain Old Telephone System (POTS) channel, a wireless channel including mobile phone, pager, and satellite channels, the Internet, or any other communication channel that is adapted to process data. In one embodiment, the first communication channel 120 and the second communication channel 150 are the same channel, however, in another embodiment, the first communication channel 120 and the second communication channel 150 are different communication channels. The data entry device 160 is any device having the ability to transmit human-perceivable information and to receive an input, whether verbal, a touch-tone, or data, for example, and may be embodied as a mobile phone, a smart phone, a Plain Old Telephone System phone, or a handheld computer, for example.

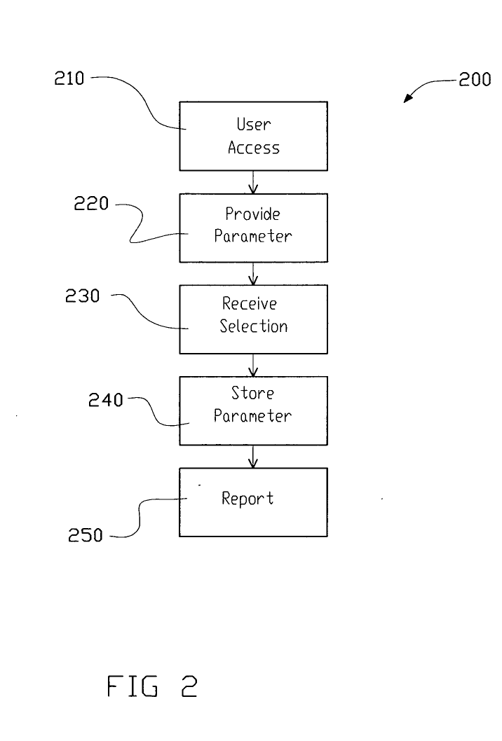

FIG. 2 is a flow diagram of a method of establishing parameters and attribute triggers. Parameters typically define data one would associate with a financial transaction or a user. For example, common parameters include the amount of a transaction, the frequency of a transaction, the time of day a transaction is processed, the geographic location of a transaction, the geographic distance from the last transaction point, the merchant processing the transaction, or any of literally hundreds of parameters known in the field of financial transaction verification. Each parameter has a range of possible values or data called attributes. Attribute triggers (or, simply “triggers”) are specific values or data set associated with a parameter. For example, one may wish to trigger any transaction attempt that is over $500 in value, trigger transactions taking place within three minutes of each other, foreign transactions, transactions taking place more than fifty miles from the last transaction point on the same day, and known pornography merchants. A user parameter profile may be defined by a single parameter, default parameters, or a plurality of parameters. Accordingly, the invention is in one embodiment a method of defining a financial processing verification system parameter for a user (the method 200).

In one embodiment, a user may select a “lost wallet/purse” feature. When this feature is activated, every transaction requires the user's explicit approval, as described herein. This can be achieved by adding an act in the processing methodology, or by setting all flags to their most sensitive value. For example, the distance of a transaction from a designated point or area could be set to O-feet. The lost wallet feature may be activated/deactivated via the internet, telephone (including cell phone) or other means. Similarly, an “approve all” feature is available whereby all flags are turned off or a separate approval-all flag is set, which gives the user more flexibility when traveling, or shopping for high-dollar items, for example. However, it is understood that the “lost wallet” feature overrides even the “approve all” feature.

The method 200 begins when a verification system receives user identification data and authentication data in a user access act 210 (basically a user log-in). The method then provides the user with at least one parameter choice in a provide parameter act 220. For example, the method 200 may ask a user if they wish to select a desired transaction amount to set as a trigger. The method 200 may present a user with several choices until all parameter options available are exhausted. Eventually, the method 200 will receive an indication of a selected parameter in a receive selection act 230. The method 200 may state defaults for some or all the parameters, and the user may accept or reject each proposed default, or defining a value of their own. In any event, the selection of a value or data associated with the parameter establishes an attribute trigger associated with the parameter in a store parameter act 240. At this point it is appropriate to point out that the term “trigger” is used because if a proposed transaction has an attribute associated with a parameter, and that characteristic exceeds the allowable parameter definition, then the system is triggered to contact the user and the user is asked to authenticate the transaction via entry of an authentication data, discussed in greater detail below. Following the selection of parameters and attribute triggers, the method 200 may store a selected parameter and attribute trigger, such as in a financial transaction processing center or in an authentication center in a report act 250.

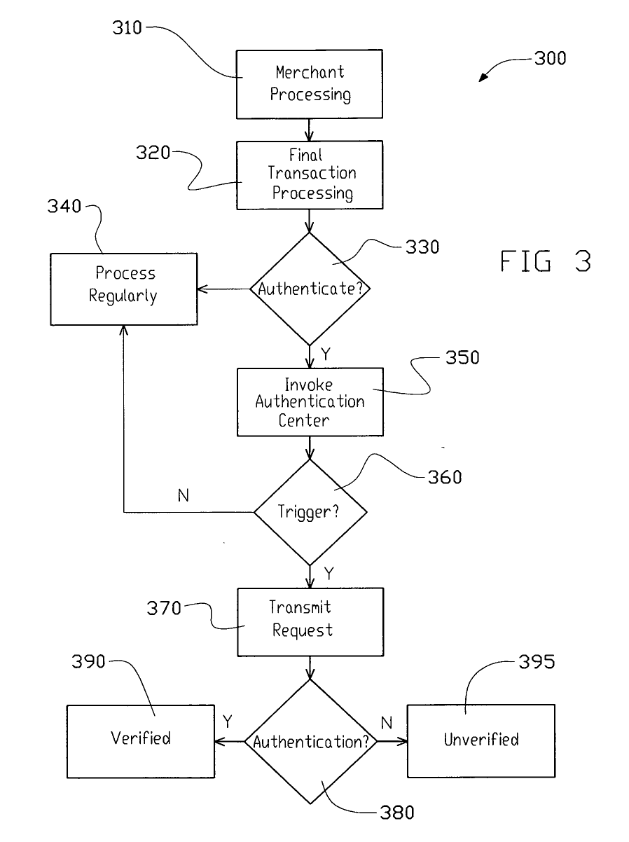

FIG. 3 is a flow diagram of a method of securely processing a financial transaction (the method 300). The method 300 may begin as an ordinary merchant transaction whereby a merchant (or other person/entity receiving a payment, including an entity running an internet service/payment system) begins the financial transaction in a processing act 310. Further, as an ordinary transaction, the financial transaction information, including user data, is passed to a financial transaction processing system in a financial transaction processing act 320. Next, the financial transaction processing system queries a database or other system to check if the user data is associated with a user parameter profile in a user profile query 330. If the user data is not associated with a user parameter profile, illustrated by the “N” decision path, then the method 300 proceeds to process the transaction normally (meaning, as if the invention were not implemented on the system) in a normal processing act 340. If, however, the user data is associated with a user parameter profile, illustrated by the “Y” decision path, then the method 300 proceeds to process the transaction by invoking an authentication center in an invoke authentication center act 350.

Accordingly, in the invoke authentication center act 350, the authentication center then receives a request to verify the financial transaction from the financial transaction processing center. First, the authentication center compares attributes of the financial transaction to the user-selected or default parameter attributes to see if a financial transaction attribute invokes a trigger. An attribute trigger is said to be activated (or, invoked) when the financial transaction value falls within the range of appropriate attribute trigger value(s), or when the financial transaction data falls within the set of appropriate trigger value data. Accordingly, parameter triggers are tested in a trigger query 360. When no trigger is activated, shown by the “N” path, the method 300 returns a “process regularly” command to the financial transaction processing center in the process regularly act 340. However, when a trigger is activated, shown by the “Y” path, the method 300 forwards a request for authentication to the user in a transmit request act 370.

Next, the user will usually respond to the request act 370. Accordingly, the method 300 proceeds with a receive authentication query 380. If the correct response is received in the authentication query, then the method 300 proceeds to an authenticated act 390, whereby a user verified command is sent as a verification indication, illustrated by the “Y” decision, to the financial transaction processing center, or, in one embodiment, the actual merchant. In the event that either an incorrect response is received, or no response at all is received within a predetermined time in the authentication query 380, then the method 300 continues with an unverified act 395 whereby a user not-verified command is generated for the financial transaction processing center or the merchant, as shown by the “N” decision path. In one embodiment, failed transaction events are delineated by an unverified indication being generated when no verification response is received from the user, and a failed indication is generated when an incorrect response is received from the user. A financial transaction processing center or a merchant may then treat these two types of failure events differently.

Presumably, when a not-verified indication is received by the person or entity processing the transaction (the processor), the transaction ceases processing. However, in one embodiment, the processor may override the system by directly taking responsibility for the transaction—effectively co-signing the transaction.

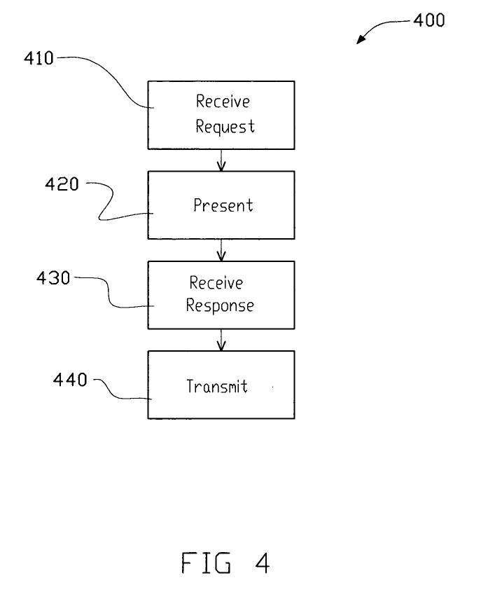

FIG. 4 is a flow diagram of a method of using a financial processing verification system to authenticate a transaction (the method 400). The method 400 begins when a data entry device receives a request to verify a financial transaction from an authentication center in a receive request act 410. Next, the method 400 presents the request to a user in a present act 420. The presentation may audibly play a request, or visually display the request. Common request could include a simple “do you wish to complete the present pending transaction,” a request for the user's mother's maiden name, a personal identification code, an address, a password, a song, key sequence, or some other information or data presumably known only to the user. Of course, the information or data requested may vary with each request, and may be a function of the dollar amount or nature of the transaction. For example, transactions between $100 and $500 may require a simple “yes” response to a “complete transaction?” request, while a transaction for over $500 could require the entry of the last four digits of the user's social security number. Thus, in a receive response act 430, an authentication response is received by one of the data entry device's input systems, which are well known in the data entry device arts, and in a transmit act 440, the authentication response is forwarded from the data entry device to the authentication center.

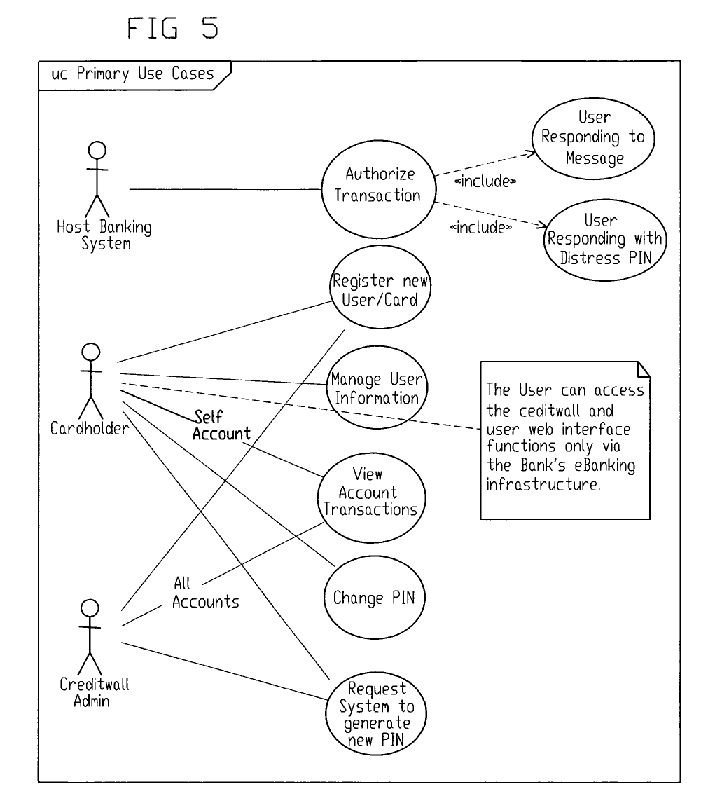

FIGS. 5-12 refer to more specific exemplary embodiments of the invention. It should be noted that the drawings sometimes refer to a “credit wall” or “CW.” Credit wall is the name being adopted by the inventor to refer to those systems and technologies that are needed to implement his methodologies. At times, credit wall is used as an adjective used to modify the names of various systems, such as an administrator (as shown in FIG. 5) as a credit wall administrator. In this context, the administrator is associated with a credit wall system, as opposed to the administrators of other systems, such as a banking administrator.

The following architecture description identifies various functional blocks that constitute the exemplary solution, and typically identify the responsibilities and interfaces for each functional block. In general, the invention includes a “core system” and an “administration application” preferably hosted by financial transaction processors, as well as an “end user application” hosted by the issuer of the card (most likely a bank or other financial institution, such as a brokerage, credit union, or insurance company, for example). The systems incorporate secure connectivity for data flow between the various components.

FIG. 5 illustrates access from a functionality perspective. The host banking system simply makes the transaction authorization decision (whether from a user responding to the purchase inquiry with a PIN or “yes”, or with a distress PIN). The cardholder completes tasks including registration, managing user information, viewing transaction information, and changing PIN(s). Likewise, the credit wall administrator also needs to be able to complete registration, view transactions, and requesting new PINs. In the embodiment shown in FIG. 5, the user would access the infrastructure via a bank's “online banking” system, however, in other embodiments, the user could have access to the invention's infrastructure via dedicated webpage(s), or remotely via handheld computing, for example. The distress PIN is a PIN the user selects to complete the transaction, but to also inform the system and/or authorities that the user completed the transaction against their will and that they need immediate assistance.

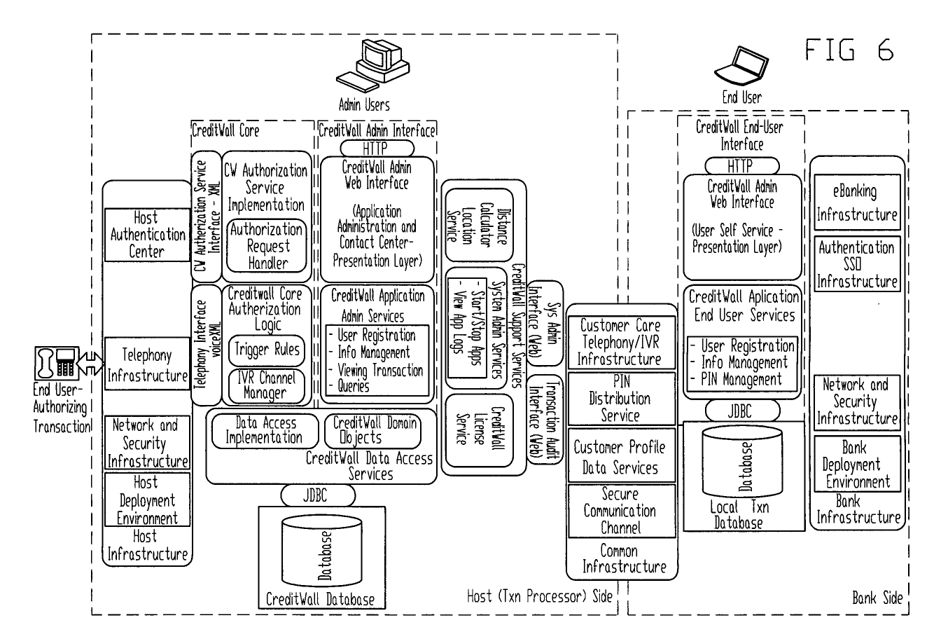

FIG. 6 is an overview of an exemplary architecture of the over-arching system. For the system of FIG. 6, the core system and administration interface system are deployed within the financial transaction processing system. However, it is appreciated by those of skill in the computer arts upon reading this disclosure that the core system can be deployed independently, or within the structure of any provider involved in the financial transaction. Further, although the end user authorizing transaction is illustrated as a telephone, it is understood that authorization may also be achieved via cell phones, mobile devices, or other communication devices.

The administration application provides a web interface for application administrators and contact center personnel to manage the invention. This solution is preferably three-tier. The logic layer contains the core logic to provide administrative functions, including: user/card processing, user information management, PIN management, and transaction viewing. Preferably, the application is available to authorized administrative (admin) users with the host (typically the financial institution) network.

The end user system provides end-users self-service capabilities, preferably through a web-based interface. The application integrates with the financial institution's/host via a link and also integrates with the security (SSO) infrastructure. This application provides user services such as: registration (both user and card), user information management, PIN management, and transaction viewing.

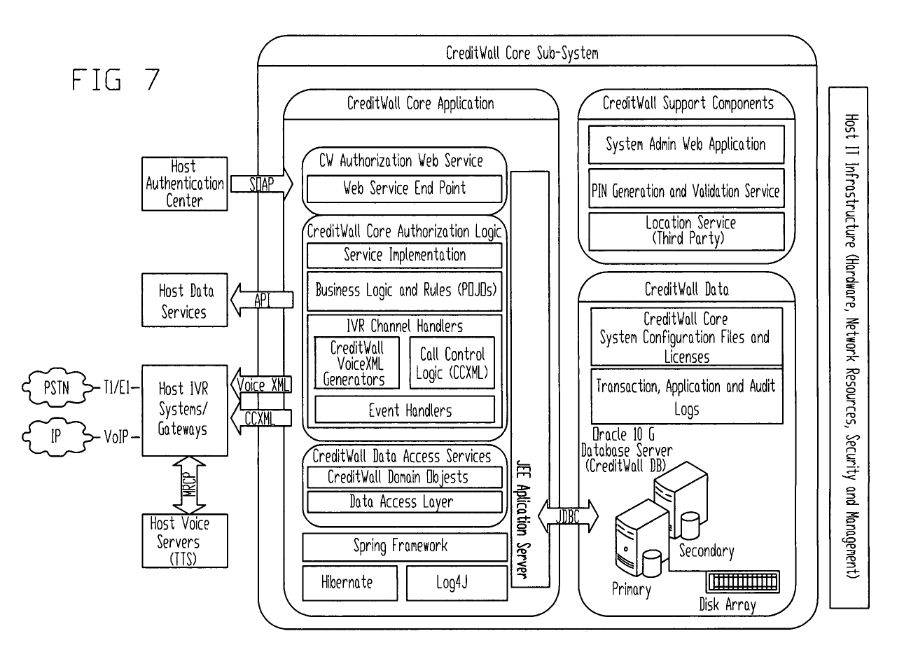

FIG. 7 is an overview of an exemplary architecture of the inventive core system. The core system is the main provider of authorization service to the financial services provider. The invention provides preferably web-based interfaces for the host to send an authorization request. The authorization request includes information about the card used, the merchant, and transaction details. The invention uses these details, the cardholder profile, and triggers (if any) to determine whether an explicit confirmation by the user is required. When that explicit user confirmation is required, the invention via its channel handler uses a telephony infrastructure or computer infrastructure (preferably of the host) to communicate with the card holder. Generally, the core system comprises a core application, a support component system, and a data system, as well as interface components, rules engines for triggers, communication channel handler and web services implementations.

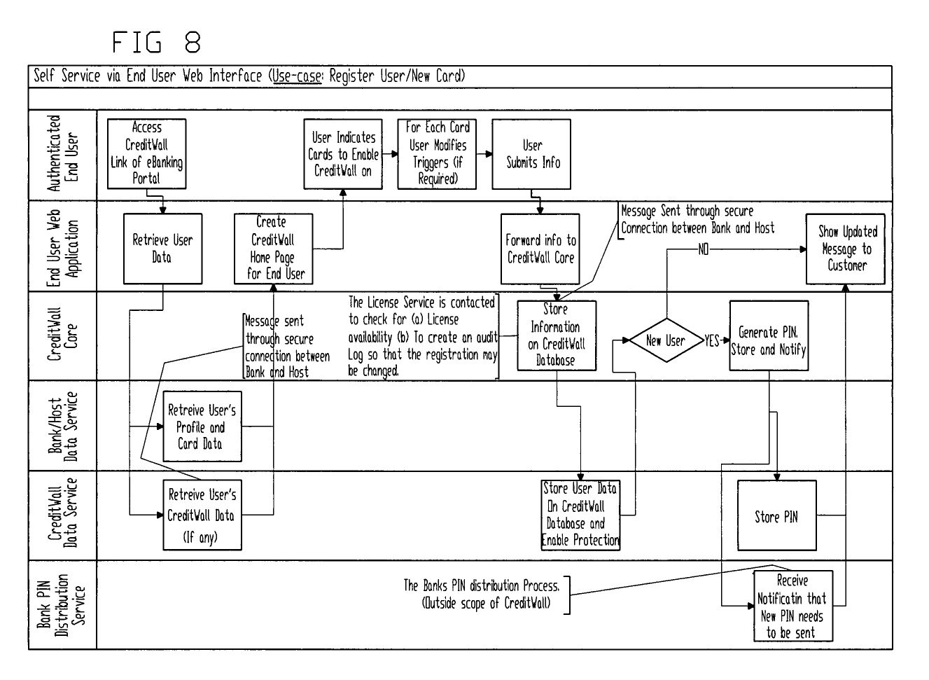

FIG. 8 is a block-flow diagram illustrating the acts for a user registration. FIG. 8 specifically illustrates a registration process usable with “online banking” systems, where a user logs into their financial institutions website, and from there register to use the invention.

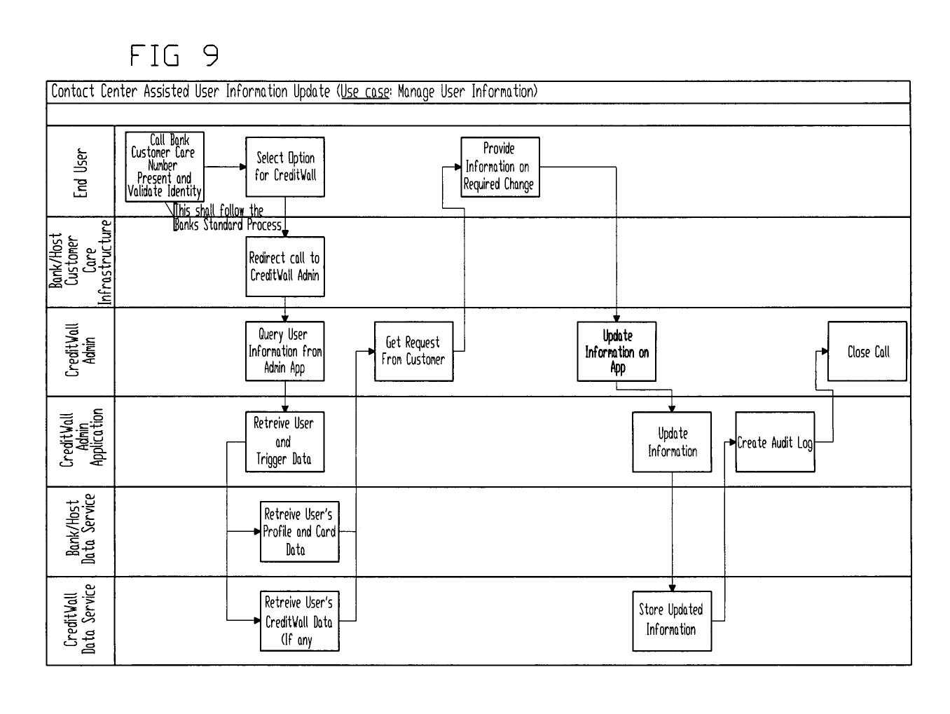

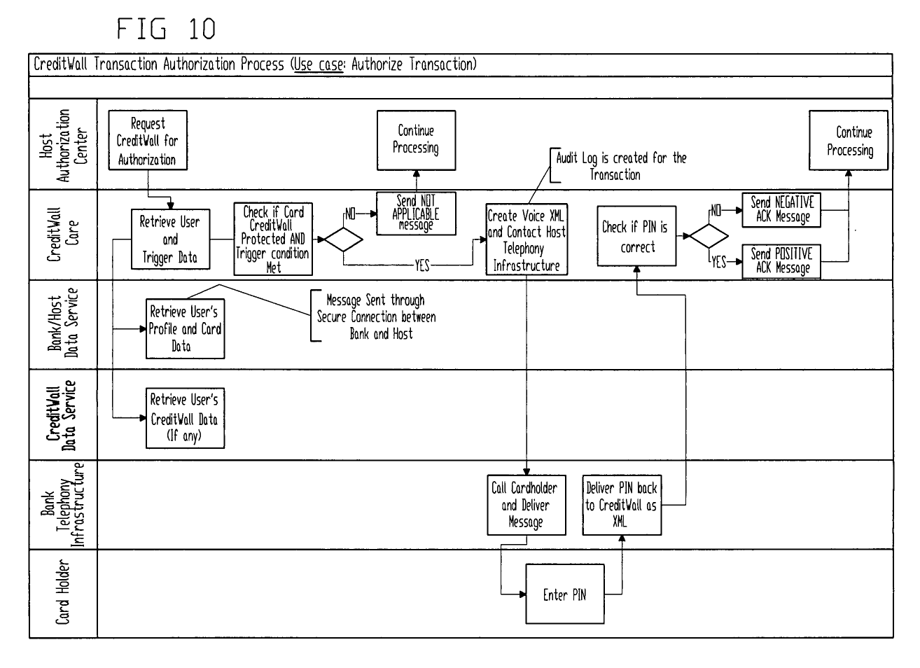

Here, as well as in FIGS. 9 and 10, process flow is read left to right, with the location of that act being shown by the vertical position of the act. Further, it is appreciated by those of skill in the art that the acts discussed in FIGS. 8-10 are preferably implemented as software modules. Furthermore, those items set by a bracket, and not within boxes or diamonds, are comments and not acts, as is understood by those of skill in the computing arts. Also, steps directly above one-another are preferably processed in parallel (simultaneously).

FIG. 9 is a block-flow diagram illustrating the acts for contact center assistance. The process illustrated in FIG. 9 is tailored for online banking, but can be modified to provide customer-service flow for any system implementation.

FIG. 10 is a block-flow diagram illustrating the acts for a transaction authorization. As shown in FIG. 10, it is assumed that a trigger data, profile, card data and other data are in the system. When a user attempts a transaction, this data (trigger data, and profile data, card data, etc. as needed) is fetched. Next, the method checks to see if a trigger condition is met. If no trigger condition is met, then the transaction is processed as usual, as shown as a “NO” decision. If a trigger condition is met, them the system continues to generate a voice-based call to the user (of course, a text message may also be used). In FIG. 10, the financial institutions telephony system is used, however, it should be understood that the call may be generated at any point in the system and/or independently (indeed, it will be appreciated by those of skill in the art upon reading the disclosure that many of the functions illustrated in FIGS. 8-10 may be performed at any of several points in the over-arching system, or independently of it). Continuing with FIG. 10, the user enters their PIN(s) or other authentication verification, which is delivered back to the system. Next the PIN is checked. If it is correct, it is noted and that information is passed to the authentication center; if it is incorrect, that fact is noted and the information is likewise passed to the authentication center.

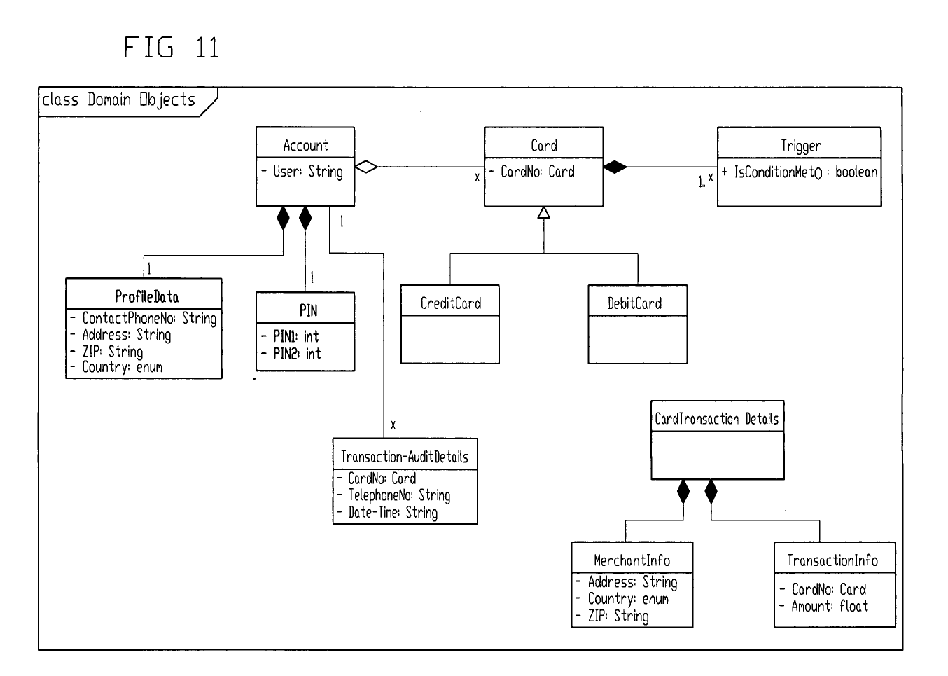

FIG. 11 illustrates a domain object model overview. The domain object model identifies the primary data elements on which the inventive system operates, and specifies the relation these data elements have with each other. The persistence mechanism used by the system is used for storage of this data. Domain Objects include: account, card, triggers, card transaction details, and card transaction audit details.

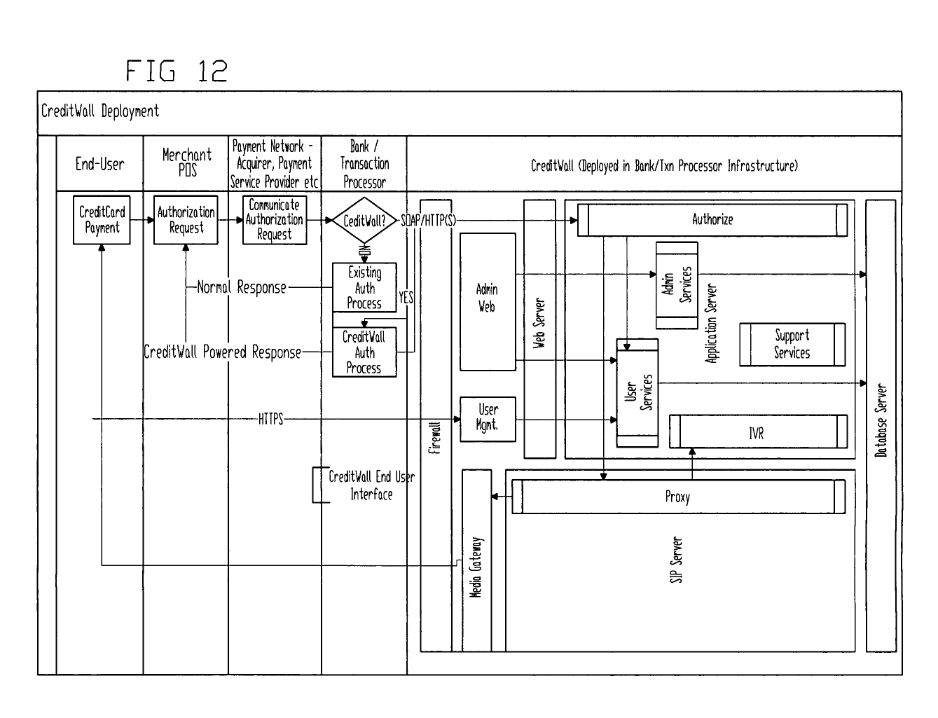

FIG. 12 shows an exemplary deployment scenario. The deployment scenario illustrates selected functional blocks, their deployment points across the system, as well as some of the functional flow of a transaction being processed. Note that a transaction may be “credit wall powered” meaning that the merchant may be able to see that the transaction was approved using the invention. In these cases, the merchant services provider or the merchant or the transaction provider may pass a savings to any other party in the transaction because the transaction is verified.

Of course, it should be understood that the order of the acts of the algorithms discussed herein may be accomplished in different order depending on the preferences of those skilled in the art, and such acts may be accomplished as software. Furthermore, though the invention has been described with respect to a specific preferred embodiment, many variations and modifications will become apparent to those skilled in the art upon reading the present application. Specifically, the invention may be altered, in ways readily apparent to those of ordinary skill in the art upon reading the present disclosure, for use as a credit application verification service, or for verifying any other form of personal identification or personal identification application(s), such as in driver's license applications, social security card applications, or other Official Document application and/or use, particularly in those areas where identity theft is a concern. It is therefore the intention that the appended claims and their equivalents be interpreted as broadly as possible in view of the prior art to include all such variations and modifications.

1. A method of securely processing a financial transaction, comprising:
receiving a request to verify a financial transaction from a financial transaction processing center, the request identifying a user;
comparing attributes of the financial transaction to predefined parameters of the user;
selectively forwarding a request for authentication to the user when an attribute trigger associated with a parameter is activated; and
sending a verification indication to the financial transaction processing center when a proper verification response is received from the user.

2. The method of claim 1 wherein the parameter is user-defined.

3. The method of claim 1 further comprising receiving a request to verify a financial transaction at a financial transaction processing center from a merchant on a first communication link, and forwarding the request for authentication on a second communication link.

4. The method of claim 1 further comprising sending an unverified indication to the financial transaction processing center when no verification response is received from the user.

5. The method of claim 1 further comprising sending a failed indication to the financial transaction processing center when an incorrect response is received from the user.

6. The method of claim 3 wherein the second communication link is a wireless communication link.

7. The method of claim 3 wherein the second communication link is a Plain Old Telephone System link.

8. A method of defining a financial processing verification system parameter for a user, comprising:
receiving user identification data and authentication data;
providing the user with at least one parameter choice;
receiving an indication of a selected parameter; and
defining an attribute trigger associated with the parameter.

9. The method of claim 8 further comprising storing the selected parameter and attribute trigger in a authentication center.

10. The method of claim 8 wherein the parameter is associated with a financial transaction attribute.

11. A financial processing verification system, comprising:
a first communication channel;
a financial transaction processing center in communication with the first communication channel;
an authentication center in communication with the financial transaction processing center;
a second communication channel in communication with the authentication center; and
a data entry device in communication with the second communication channel.

12. The method of claim 11 wherein the second communication channel is a wireless communication channel.

13. The method of claim 11 wherein the authentication center is adapted to:
receive a request to verify a financial transaction from a financial transaction processing center, the request identifying a user;
compare attributes of the financial transaction to predefined parameters of the user;
selectively forward a request for authentication to the user when an attribute trigger associated with a parameter is activated; and
send a verification indication to the financial transaction processing center when a proper verification response is received from the user.

14. The method of claim 11 wherein the data entry device is a mobile phone.

15. The method of claim 11 wherein the data entry device is a Plain Old Telephone System phone.

16. The method of claim 11 wherein the data entry device is a handheld computer.

17-19. (canceled)
